(19) United States
(12) Patent Application Publication
(10) Pub. No.: US 2013/0235469 A1
(43) Pub. Date: Sep. 12, 2013

(54) DUAL-MOTOR LENS ACTUATING DEVICE AND DUAL-MOTOR LENS ACTUATING METHOD THEREOF

(71) Applicant: Ming-Shan CHAN, Taoyuan County (TW)

(72) Inventor: Ming-Shan CHAN, Taoyuan County (TW)

(21) Appl. No.: 13/474,271

(22) Filed: May 17, 2012

(30) Foreign Application Priority Data
Mar. 7, 2012 (TW) 101107721

(51) Int. Cl. G02B 7/04

(52) U.S. Cl. 359/696

(57) ABSTRACT

The present invention discloses a dual-motor lens actuating device and method thereof. The device comprises a first backup plate, second backup plate, first driving motor, second driving motor, position sensor, step sensing unit and microcontroller. The first backup plate is installed to a zoom lens group; the second backup plate is installed to a focus lens group. The first driving motor and the second driving motor drive the movements of the zoom lens group and focus lens group respectively. The position sensor senses positions of the first and second backup plates to transmit a position signal. The step sensing unit senses movements corresponding to the lens groups to transmit a step signal. The microcontroller controls the first driving motor and the second driving motor to drive the movements of the zoom lens group and focus lens group according to the position signal and step signal.

### CROSS-REFERENCE TO RELATED APPLICATION

This application claims the benefit of Taiwan Patent Application No. 101107721, filed on Mar. 7, 2012, in the Taiwan Intellectual Property Office, the disclosure of which is incorporated herein in its entirety by reference.

### BACKGROUND OF THE INVENTION

1. Field of the Invention

The present invention relates to a dual-motor lens actuating device and a dual-motor lens actuating method thereof, and more particularly to the dual-motor lens actuating device and method that use a single position sensor to control a zoom lens group and a pair of focus lens groups to return to their mechanic origin.

2. Description of Related Art

At present, most cameras available in the market generally come with zooming and focusing functions, and these functions are driven and controlled by a DC motor and a step motor respectively. It is noteworthy to point out that each of the conventional lenses including a zoom lens group and a pair of focus lens groups has a position indicator for assisting the zoom lens group and the pair of focus lens groups to return to their mechanical origin. In other words, the camera lens requires two position indicators to control the zoom lens group and the pair of focus lens groups and two sets of control circuits for the control, so that the cameras incur a higher cost and consume more power.

According to the requirement, designing a dual-motor lens actuating device and a dual-motor lens actuating method to lower the cost of the lenses and save power demands immediate attention and feasible solutions.

### SUMMARY OF THE INVENTION

In view of the aforementioned problems of the prior art, it is a primary objective of the invention to provide a dual-motor lens actuating device and a dual-motor lens actuating method thereof to overcome the problems of the prior art.

To achieve the foregoing objective, the present invention provides a dual-motor lens actuating device comprising a first backup plate and a second backup plate, a first driving motor and a second driving motor, a position sensor, a step sensing unit and a microcontroller. The first backup plate is installed on a side of a zoom lens group, and the second backup plate is installed on a side of a pair of focus lens groups, and a pair of focus lens groups is installed under the zoom lens group. The two driving motors are provided for driving the movements of the zoom lens group and the pair of focus lens groups respectively. The position sensor is provided for sensing positions of the first backup plate and the second backup plate to issue a position signal corresponding to the first backup plate and the second backup plate. The step sensing unit is provided for sensing motions of the zoom lens group and the pair of focus lens groups to issue a step signal. The microcontroller is provided for controlling the two driving motors to drive the movements of zoom lens group or the pair of focus lens groups, receiving the position signal of the first backup plate and the second backup plate and the step signal corresponding to the zoom lens group and the pair of focus lens groups, and also for controlling the movements of the zoom lens group and the pair of focus lens groups according to the position signal and the step signal. Wherein, at an initial state, the microcontroller controls the first driving motor to drive the zoom lens group to rotate outwardly in first direction, and when the zoom lens group is rotated outwardly in first direction and the microcontroller has not received the position signal issued by the position sensor, the first driving motor continues driving the zoom lens group to rotate outwardly in first direction; and when the microcontroller receives the position signal, the microcontroller controls the zoom lens group to stop moving according to the position signal and the step signal and controls the second driving motor to drive the pair of focus lens groups to rotate outwardly in first direction.

Wherein, when the microcontroller controls the second driving motor to drive the pair of focus lens groups to rotate outwardly in first direction and the microcontroller has not received the position signal, then one of the two driving motors will continue driving the pair of focus lens groups to rotate outwardly in first direction.

Wherein, when the microcontroller receives the position signal issued by the position sensor, the microcontroller will control the pair of focus lens groups to stop moving according to the position signal and the step signal.

Wherein, the microcontroller further comprises a shutdown detection unit for detecting whether the dual-motor lens actuating device is shut down with a normal shutdown, and when the dual-motor lens actuating device is shut down with a normal shutdown, the shutdown detection unit writes normal shutdown information into the microcontroller.

Wherein, when the microcontroller has not read the normal shutdown information, then the microcontroller will control the second driving motor to drive the pair of focus lens groups to rotate in second direction to a step with the farthest stroke, and will control the first driving motor to drive the zoom lens group to rotate and move in second direction.

Wherein, when the microcontroller has not read the normal shutdown information, and the microcontroller controls the first driving motor to drive the zoom lens group to rotate and move in second direction, then the microcontroller will receive the step signal corresponding to the zoom lens group; and when the microcontroller has not received the step signal for a predetermined time, then the microcontroller will control the first driving motor to stop driving the zoom lens group to move.

To achieve the aforementioned objective, the present invention further provides a dual-motor lens actuating method dual-motor lens actuating method, applicable for a dual-motor lens actuating device, and the method comprises the steps of: installing a first backup plate onto a side of a zoom lens group and a second backup plate onto a side of a pair of focus lens groups, and installing the pair of focus lens groups under the zoom lens group; using a first driving motor and a second driving motor to drive the movements of the zoom lens group and the pair of focus lens groups respectively; using a position sensor to sense a position of the first backup plate or the second backup plate to issue a position signal corresponding to the first backup plate and the second backup plate; sensing a motion of the zoom lens group and the pair of focus lens groups through a step sensing unit to issue a step signal; using a microcontroller to control the first driving motor and the second driving motor to drive the movements of the zoom lens group or the pair of focus lens groups; receiving the position signal of the first backup plate and the second backup plate and the step signal corresponding to the zoom lens group and the pair of focus lens groups through the microcontroller; and controlling the movements of the zoom lens group and the pair of focus lens groups according to the position signal and the step signal by the microcontroller; such that at an initial state, the microcontroller controls the first driving motor to drive the zoom lens group to rotate outwardly in first direction, and when the zoom lens group is rotated outwardly in first direction and the microcontroller has not received the position signal issued by the position sensor, the first driving motor continues driving the zoom lens group to rotate outwardly in first direction, and when the microcontroller receives the position signal, the microcontroller controls the zoom lens group to stop moving according to the position signal and the step signal, and controls the second driving motor to drive the pair of focus lens groups to rotate outwardly in first direction.

In summation, the dual-motor lens actuating device and method in accordance with the present invention have one or more of the following advantages:

(1) The dual-motor lens actuating device and method primarily use a single microcontroller and a position sensor to control the zoom lens group and the pair of focus lens groups to move to the mechanical origin. Such arrangement not only reduces the lens component to lower the manufacturing cost, but also reduces the power consumption of the camera to better meet the user requirements.

(2) The dual-motor lens actuating device and method primarily uses the microcontroller and the single position sensor to detect the zoom lens group and the pair of focus lens groups and control both motors in whether or not to drive the two lens groups according to the position signal and the step signal, so as to also overcome the problems occurred in an abnormal shutdown.

### BRIEF DESCRIPTION OF THE DRAWINGS

FIG. 1 is a block diagram of a dual-motor lens actuating device of the present invention;

FIG. 2 is a schematic view of a dual-motor lens actuating device in accordance with a first preferred embodiment of the present invention;

FIG. 3A is a first flow chart of a dual-motor lens actuating method in accordance with the first preferred embodiment of the present invention;

FIG. 3B is a second flow chart of a dual-motor lens actuating method in accordance with the first preferred embodiment of the present invention;

FIG. 4 is a schematic view of a dual-motor lens actuating device in accordance with a second preferred embodiment of the present invention;

FIG. 5A is a first flow chart of a dual-motor lens actuating method in accordance with the second preferred embodiment of the present invention;

FIG. 5B is a second flow chart of a dual-motor lens actuating method in accordance with the second preferred embodiment of the present invention; and

FIG. 5C is a third flow chart of a dual-motor lens actuating method in accordance with the second preferred embodiment of the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent respective same elements.

The dual-motor lens actuating device and method of the present invention are applicable for cameras including digital cameras, Smartphones, and single lens reflex cameras, but the applications of the present invention are not limited to cameras only.

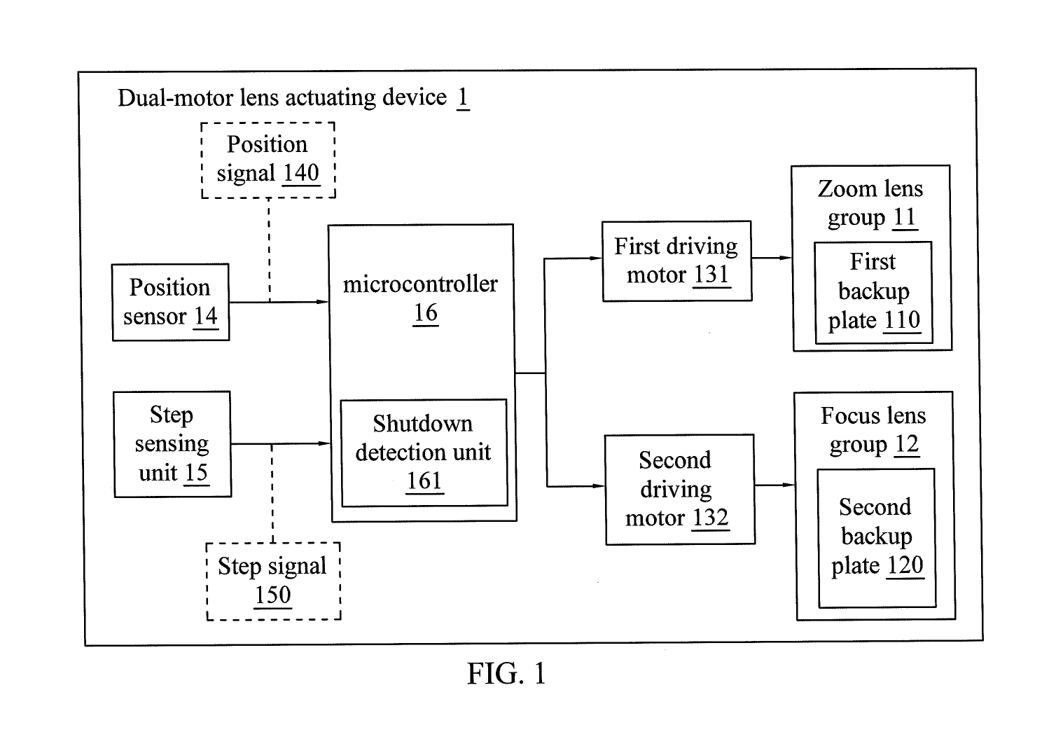

With reference to FIG. 1 for a block diagram of a dual-motor lens actuating device of the present invention, the dual-motor lens actuating device 1 comprises a zoom lens group 11, a pair of focus lens groups 12, a first driving motor 131, a second driving motor 132, a position sensor 14, a step sensing unit 15 and a microcontroller 16. A first backup plate 110 is installed on a side of the zoom lens group 11, a second backup plate 120 is installed on a side of the pair of focus lens groups 12, and the pair of focus lens groups 12 are installed under the zoom lens group 11. The first driving motor 131 and the second driving motor 132 can be DC motors or step motors used for driving the movements of the zoom lens group 11 or the pair of focus lens groups 12. The position sensor 14 can be a photo interrupter or a position indicator (PI) used as a positioning and sensing component, and the position sensor 14 can sense the positions of the first backup plate 110 and the second backup plate 120 to issue signals of the first backup plate 110 and the second backup plate 120 respectively. The step sensing unit 15 can sense the motion of the zoom lens group 11 and the pair of focus lens groups 12 to issue a step signal 150. The microcontroller 16 can be a micro control unit (MCU) and includes a shutdown detection unit 161 for detecting whether the dual-motor lens actuating device 1 is shut down with a normal shutdown. When the dual-motor lens actuating device 1 is shut down with a normal shutdown, then the shutdown detection unit 161 will write normal shutdown information into the microcontroller 16. The microcontroller 16 is electrically coupled to the first driving motor 131, the second driving motor 132, the position sensor 14 and the step sensing unit 15 and can control the first driving motor 131 and the second driving motor 132 to drive the movements of the zoom lens group 11 or the pair of focus lens groups 12. In addition, the microcontroller 16 can receive the position signal 140 of the first backup plate 110 and the second backup plate 120 and the step signal 150 of the pair of focus lens groups 12 and the zoom lens group 11, and further controls the movements of the zoom lens group 11 and the pair of focus lens groups 12 according to the position signal 140 and the step signal 150.

In summation, when the microcontroller 16 controls the first driving motor 131 to drive the zoom lens group 11 to rotate outwardly in first direction, the position sensor 14 will sense the position of the zoom lens group 11 to determine whether or not to issue the position signal 140. When the microcontroller 16 has not received the position signal 140, then the first driving motor 131 will continue driving the zoom lens group 11 to rotate outwardly in first direction. When the microcontroller 16 receives the position signal 140, the microcontroller 16 will control the zoom lens group to stop moving according to the position signal 140 and the step signal 150. And then, the microcontroller 16 will control the second driving motor 132 to drive the pair of focus lens groups 12 to rotate outwardly in first direction.

Therefore, when the second driving motor 132 drives the pair of focus lens groups 12 to rotate outwardly in first direction and the microcontroller 16 has not received the position signal 140, then the second driving motor 132 will continue driving the pair of focus lens groups 12 to rotate outwardly in first direction. When the microcontroller 16 receives the position signal 140, then the microcontroller can control the pair of focus lens groups 12 to stop moving according to the position signal 140 and the step signal 150.

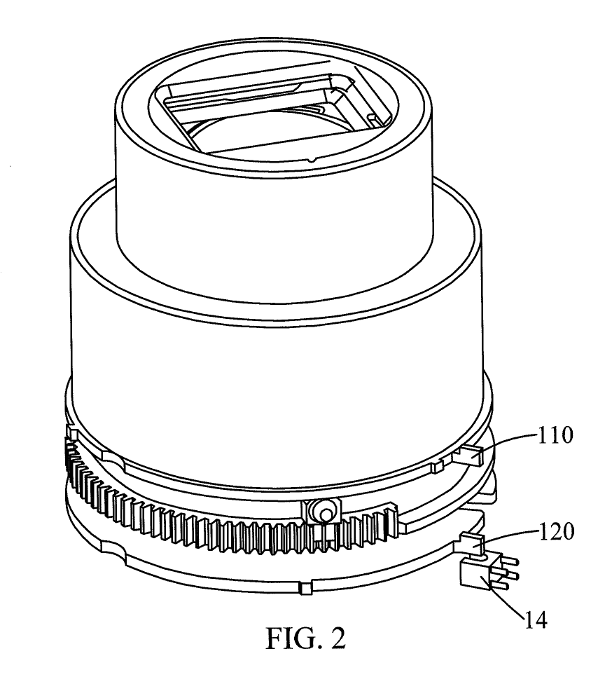

With reference to FIG. 2 for a schematic view of a dual-motor lens actuating device in accordance with a first preferred embodiment of the present invention, the dual-motor lens actuating device is applicable for camera devices, but the invention is not limited to cameras only. It is noteworthy to point out that the dual-motor lens actuating device of the present invention has a single position sensor 14. The camera lens includes a zoom lens group and a pair of focus lens groups, and the zoom lens group is installed above the pair of focus lens groups. The zoom lens group has a first backup plate 110 installed at the position of the corresponding position sensor 14, and the pair of focus lens groups have a second backup plate 120 installed at the position corresponding to the position sensor 14.

When the shutdown detection unit is in a normal shutdown status, the shutdown detection unit will write normal shutdown information into the microcontroller, such that after the camera device is turned on, the microcontroller can read the normal shutdown information, and the first driving motor can drive the zoom lens group to rotate outwardly in first direction. It is noteworthy to point out that when the zoom lens group is rotated outwardly in first direction, the position sensor 14 can detect the motion of the zoom lens group to issue a high-level signal, and the step sensing unit continues issuing the step signal according to the motion of the zoom lens group. When the microcontroller receives a low-level signal issued from the position sensor 14, the zoom lens group will be controlled to stop moving, and will drive the pair of focus lens groups to rotate outwardly in the first direction. When the second driving motor drives the pair of focus lens groups to rotate outwardly in first direction, the position sensor 14 will sense the motion of the pair of focus lens groups to issue a high-level signal. When the microcontroller receives a low-level signal issued from the position sensor 14, the microcontroller will control the pair of focus lens groups to stop moving, and the step sensing unit will stop issuing the step signal to complete the forward rotation of the camera lens.

Even though the concept of the dual-motor lens actuating method of the dual-motor lens actuating device of the present invention, the following flow chart is provided for illustrating the concept more clearly.

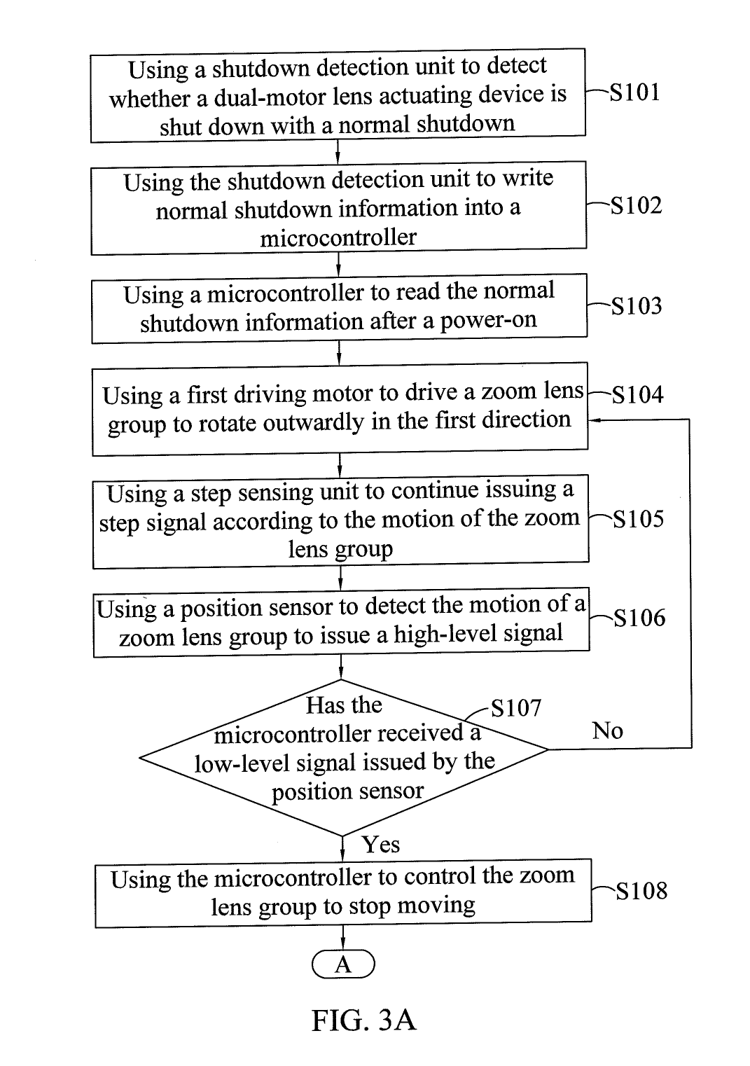

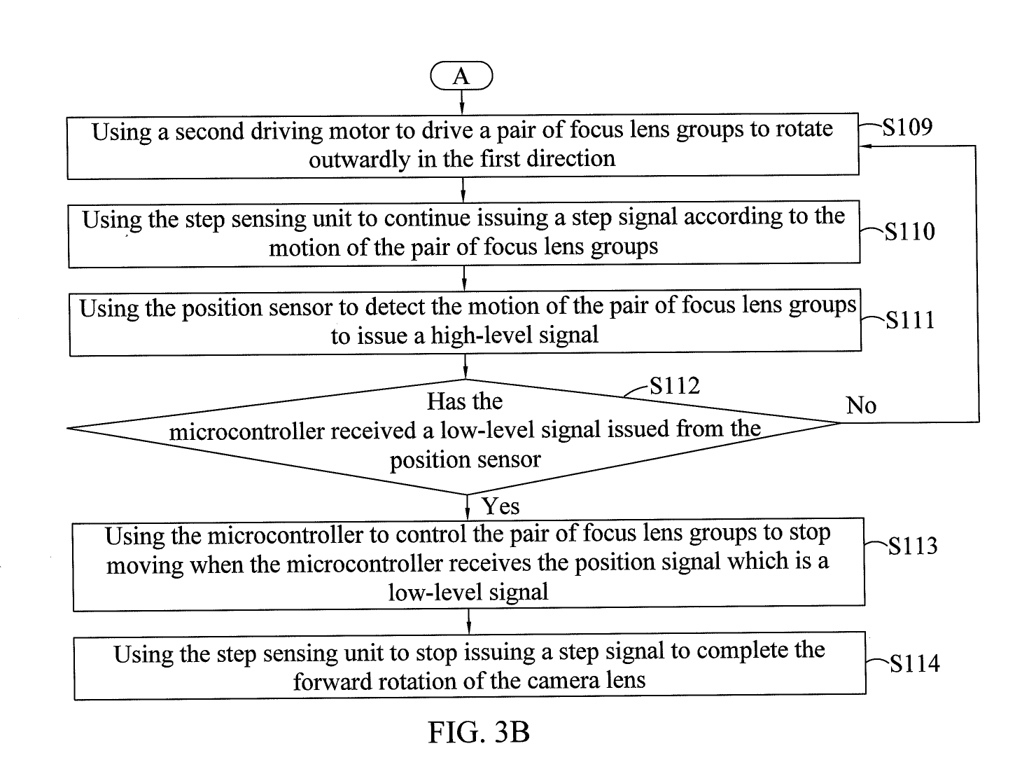

With reference to FIGS. 3A and 3B for the first and second flow charts of a dual-motor lens actuating method in accordance with the first preferred embodiment of the present invention respectively, the dual-motor lens actuating method is applicable in a dual-motor lens actuating device, and the dual-motor lens actuating device comprises a zoom lens group and a pair of focus lens groups, having a first backup plate and a second backup plate respectively; a first driving motor and a second driving motor, for respectively driving the movements of the zoom lens group and a pair of focus lens groups; and a position sensor, a step sensing unit and a microcontroller. In FIGS. 3A and 3B, the dual-motor lens actuating method comprises the following steps:

S101: Using a shutdown detection unit to detect whether a dual-motor lens actuating device is shut down with a normal shutdown.

S102: Using the shutdown detection unit to write normal shutdown information into a microcontroller.

S103: Using a microcontroller to read the normal shutdown information after a power-on.

S104: Using a first driving motor to drive a zoom lens group to rotate outwardly in the first direction.

S105: Using a step sensing unit to continue issuing a step signal according to the motion of the zoom lens group.

S106: Using a position sensor to detect the motion of a zoom lens group to issue a high-level signal.

S107: Determining whether the microcontroller receives a low-level signal issued by the position sensor.

S108: Using the microcontroller to control the zoom lens group to stop moving, when the microcontroller has received the position signal which is a low-level signal, or else go to the step S104.

S109: Using a second driving motor to drive a pair of focus lens groups to rotate outwardly in the first direction.

S110: Using the step sensing unit to continue issuing a step signal according to the motion of the pair of focus lens groups.

S111: Using the position sensor to detect the motion of the pair of focus lens groups to issue a high-level signal.

S112: Checking whether the microcontroller has received a low-level signal issued from the position sensor.

S113: Using the microcontroller to control the pair of focus lens groups to stop moving when the microcontroller receives the position signal which is a low-level signal, or else go back to the step S109.

S114: Using the step sensing unit to stop issuing a step signal to complete the forward rotation of the camera lens.

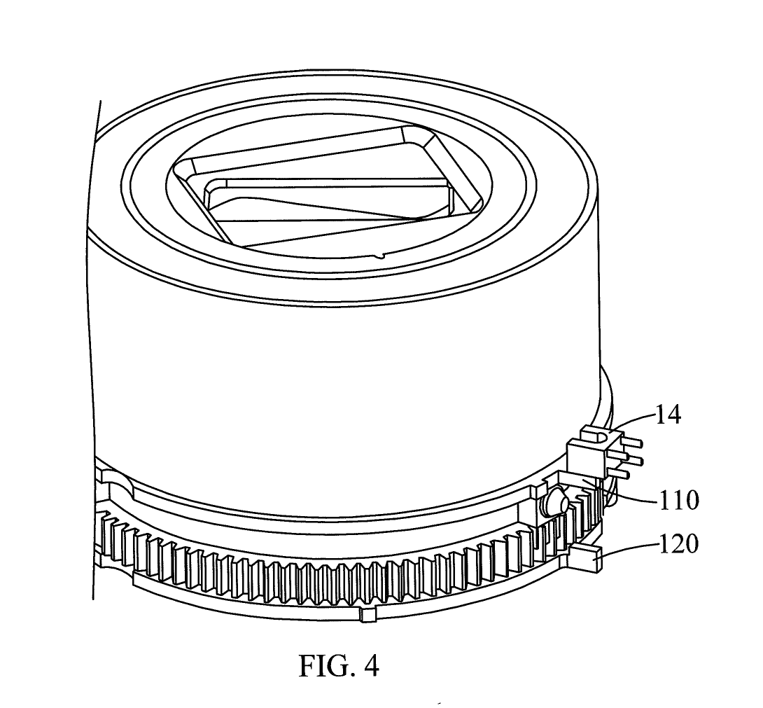

With reference to FIG. 4 for a schematic view of a dual-motor lens actuating device in accordance with the second preferred embodiment of the present invention, the dual-motor lens actuating device is applicable for camera devices, but the invention is not limited to cameras only. It is noteworthy to point out that the camera device can have a shock resisting structure (not shown in the figure), and the dual-motor lens actuating device of the present invention has a single position sensor 14. The lens comprises a zoom lens group and a pair of focus lens groups, and the zoom lens group is installed above the pair of focus lens groups. The zoom lens group includes a first backup plate 110 installed at a position corresponding to the position sensor 14, and the pair of focus lens groups have a second backup plate 120 installed at a position corresponding to the position sensor 14.

When the shutdown detection unit is not shut down with the normal shutdown but with an abnormal shutdown, then the shutdown detection unit will not take action or write the normal shutdown information into the microcontroller. Therefore, after the camera device is powered on, the microcontroller cannot read the normal shutdown information, so that the second driving motor will drive the pair of focus lens groups to rotate and move in second direction to a step with the farthest stroke, and then, the first driving motor drives the zoom lens group to rotate and move in second direction. It is noteworthy to point out that when the zoom lens group is rotated in second direction, the step sensing unit continues issuing the step signal according to the zoom lens group. The microcontroller is used to determine whether the step signal has been stopped over a predetermined time. When the step signal has been stopped for the predetermined time, then, it means that the zoom lens group has rotated back to the origin, so that the microcontroller controls the first driving motor to stop driving the zoom lens group to control the zoom lens group to stop moving. When the step signal has not been stop for the time exceeding the predetermined time, then the microcontroller will continue controlling the zoom lens group to rotate in second direction.

In other words, when the zoom lens group is rotated in second direction to the origin, it can be considered as a status of correcting the previous abnormal shutdown. In the meantime, the dual-motor lens actuating method as described in the first preferred embodiment is provided for controlling the pair of focus lens groups and the zoom lens group to rotate outwardly in first direction.

Even though the concept of the dual-motor lens actuating method of the dual-motor lens actuating device of the present invention, the following flow chart is provided for illustrating the concept more clearly.

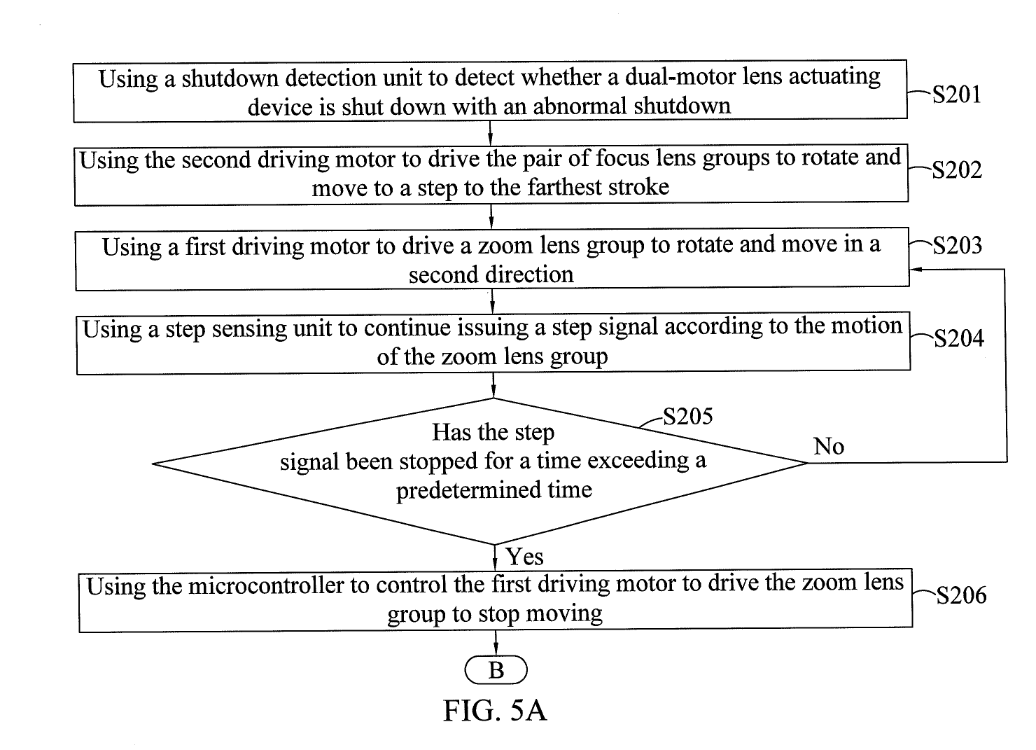

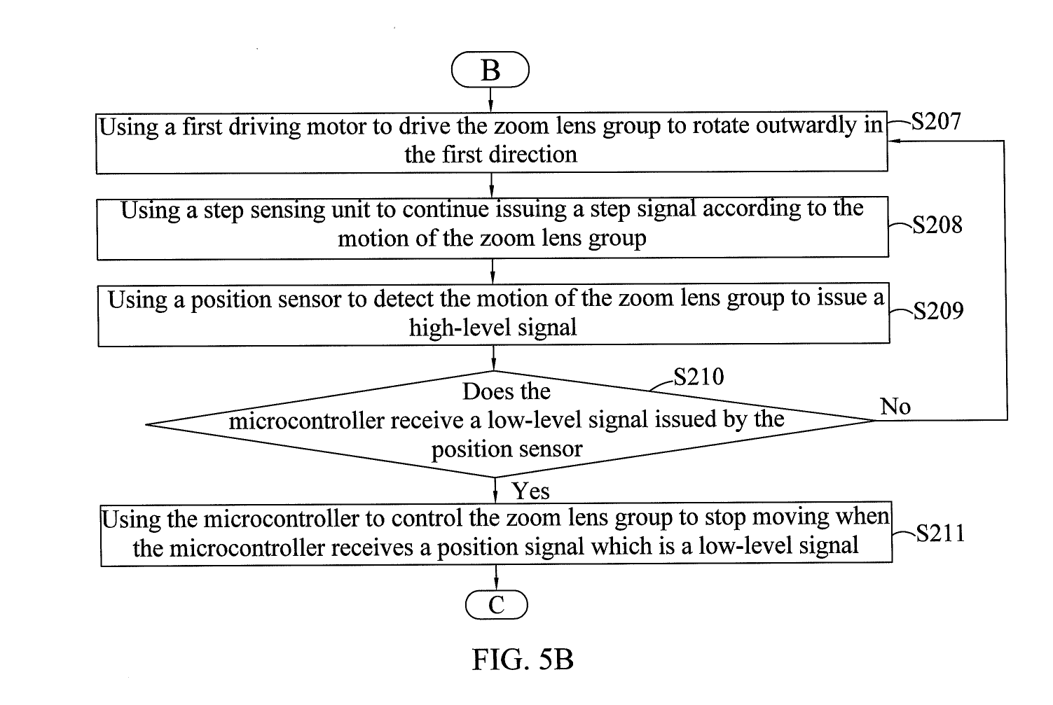

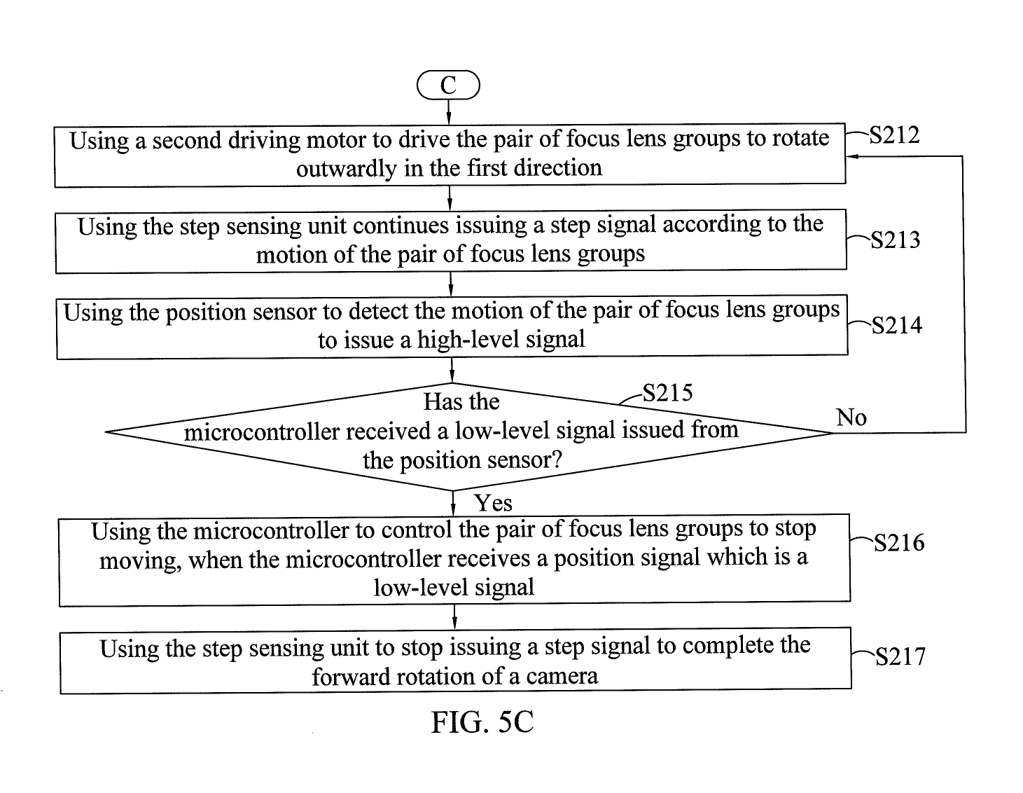

With reference to FIGS. 5A, 5B and 5C for the first, second and third flow charts of a dual-motor lens actuating method in accordance with the second preferred embodiment of the present invention respectively, the method comprises the following steps:

S201: Using a shutdown detection unit to detect whether a dual-motor lens actuating device is shut down with an abnormal shutdown.

Since the dual-motor lens actuating device is shut down with an abnormal shutdown and the microcontroller cannot read the normal shutdown information, therefore the following step S202 will be executed.

S202: Using the second driving motor to drive the pair of focus lens groups to rotate and move to a step to the farthest stroke.

S203: Using a first driving motor to drive a zoom lens group to rotate and move in a second direction.

S204: Using a step sensing unit to continue issuing a step signal according to the motion of the zoom lens group.

S205: Using the microcontroller to determine whether the step signal has been stopped for a time exceeding a predetermined time.

When the step signal has been stopped over a predetermined time, it means that the zoom lens group has been rotated in a second direction to the origin, so that the step S206 will be executed.

S206: Use the microcontroller to control the first driving motor to drive the zoom lens group to stop moving.

When the step signal has not been stopped over the predetermined time, it means that the zoom lens group has not returned to the origin, the step S203 will be executed to continue controlling the zoom lens group by the microcontroller to rotate and move in the second direction continuously.

S207: Using a first driving motor to drive the zoom lens group to rotate outwardly in the first direction.

S208: Using a step sensing unit to continue issuing a step signal according to the motion of the zoom lens group.

S209: Using a position sensor to detect the motion of the zoom lens group to issue a high-level signal.

S210: Checking whether the microcontroller receives a low-level signal issued by the position sensor.

S211: Using the microcontroller to control the zoom lens group to stop moving when the microcontroller receives a position signal which is a low-level signal, or else go to the step S207.

S212: Using a second driving motor to drive the pair of focus lens groups to rotate outwardly in the first direction.

S213: Using the step sensing unit continues issuing a step signal according to the motion of the pair of focus lens groups.

S214: Using the position sensor to detect the motion of the pair of focus lens groups to issue a high-level signal.

S215: Checking whether the microcontroller has received a low-level signal issued from the position sensor.

S216: Using the microcontroller to control the pair of focus lens groups to stop moving, when the microcontroller receives a position signal which is a low-level signal, or else return to the step S212.

S217: Using the step sensing unit to stop issuing a step signal to complete the forward rotation of a camera.

In summation of the description above, the dual-motor lens actuating device and method in accordance with the present invention use the microcontroller and a single position sensor to detect the zoom lens group and the pair of focus lens groups, and the position signal and the step signal are used to control driving the two lens groups, and the problem of the abnormal shutdown status can be overcome. The present invention not only reduces the manufacturing cost of the camera components, but also reduces the power consumption of the camera battery to meet user requirements.

What is claimed is:

1. A dual-motor lens actuating device, comprising:
a first backup plate and a second backup plate, installed on a side of a zoom lens group and a side of a pair of focus lens groups respectively, and the pair of focus lens groups being installed under the zoom lens group;
a first driving motor and a second driving motor, for respectively driving movements of the zoom lens group and the pair of focus lens groups;
a position sensor, for sensing positions of the first backup plate and the second backup plate to issue a position signal corresponding to the first backup plate and the second backup plate;
a step sensing unit, for sensing the movements of the zoom lens group and the pair of focus lens groups to issue a step signal; and
a microcontroller, for controlling the first driving motor and the second driving motor to respectively drive the movements of the zoom lens group and the pair of focus lens groups, and receiving the position signal of the first backup plate and the second backup plate and the step signal corresponding to the zoom lens group and the pair of focus lens groups, and controlling the zoom lens group and the pair of focus lens groups to move according to the position signal and the step signal;
wherein, at an initial state, the microcontroller controls the first driving motor to drive the zoom lens group to rotate outwardly in first direction, wherein when the zoom lens group is rotated outwardly in the first direction, the first driving motor continues driving the zoom lens group to rotate outwardly in first direction if the microcontroller has not received the position signal issued by the position sensor; and when the microcontroller receives the position signal, the microcontroller controls the zoom lens group to stop moving according to the position signal and the step signal, and controls the second driving motor to drive the pair of focus lens groups to rotate outwardly in the first direction.

2. The dual-motor lens actuating device of claim 1, wherein when the microcontroller controls the second driving motor to drive the pair of focus lens groups to rotate outwardly in the first direction, and when the microcontroller has not received the position signal, the second driving motor continues driving the pair of focus lens groups to rotate outwardly in the first direction.

3. The dual-motor lens actuating device of claim 2, wherein when the microcontroller receives the position signal issued by the position sensor, the microcontroller controls the pair of focus lens groups to stop moving according to the position signal and the step signal.

4. The dual-motor lens actuating device of claim 1, wherein the microcontroller further comprises a shutdown detection unit for detecting whether the dual-motor lens actuating device is shut down with a normal shutdown, and when the dual-motor lens actuating device is shut down with normal shutdown, the shutdown detection unit writes normal shutdown information into the microcontroller.

5. The dual-motor lens actuating device of claim 4, wherein when the microcontroller has not read the normal shutdown information, the microcontroller controls the second driving motor to drive the pair of focus lens groups to rotate in a second direction and move to a step with the farthest stroke, and controls the first driving motor to drive the zoom lens group to rotate and move in the second direction.

6. The dual-motor lens actuating device of claim 4, wherein when the microcontroller has not read the normal shutdown information, and the microcontroller controls the first driving motor to drive the zoom lens group to rotate and move in a second direction, the microcontroller receives the step signal corresponding to the zoom lens group; and when the microcontroller has not received the step signal for a predetermined time, the microcontroller controls the first driving motor to stop driving the zoom lens group to move.

7. A dual-motor lens actuating method, applicable for a dual-motor lens actuating device, comprising the steps of:
installing a first backup plate onto a side of a zoom lens group and a second backup plate onto a side of a pair of focus lens groups, and installing the pair of focus lens groups under the zoom lens group;
using a first driving motor and a second driving motor to respectively to drive movements of the zoom lens group and the pair of focus lens groups;
using a position sensor to sense a position of the first backup plate or the second backup plate to issue a position signal corresponding to the first backup plate and the second backup plate;
sensing the movements of the zoom lens group and the pair of focus lens groups through a step sensing unit to issue a step signal;
using a microcontroller to control the first driving motor and the second driving motor to drive the movements of lens group or the pair of focus lens groups;
receiving the position signal of the first backup plate and the second backup plate and the step signal corresponding to the zoom lens group and the pair of focus lens groups through the microcontroller; and
controlling the movements of the zoom lens group and the pair of focus lens groups according to the position signal and the step signal by the microcontroller; wherein at an initial state, the microcontroller controls the first driving motor to drive the zoom lens group to rotate outwardly in first direction, wherein when the zoom lens group is rotated outwardly in first direction, and when the microcontroller has not received the position signal issued by the position sensor, the first driving motor continues driving the zoom lens group to rotate outwardly in first direction; and when the microcontroller receives the position signal, the microcontroller controls the zoom lens group to stop moving according to the position signal and the step signal, and controls the second driving motor to drive the pair of focus lens groups to rotate outwardly in first direction.

8. The dual-motor lens actuating method of claim 7, further comprising the steps of:
using the microcontroller to control the second driving motor to drive the pair of focus lens groups to rotate outwardly in first direction; and
continuing driving the pair of focus lens groups to rotate outwardly in first direction by the second driving motor, when the pair of focus lens groups are rotated outwardly in first direction, and the microcontroller has not received the position signal.

9. The dual-motor lens actuating method of claim 8, further comprising the step of:
using the microcontroller to control the pair of focus lens groups to stop moving according to the position signal and the step signal.

10. The dual-motor lens actuating method of claim 7, wherein the microcontroller further comprises a shutdown detection unit, and the dual-motor lens actuating method further comprises the steps of:
using the shutdown detection unit to detect whether the dual-motor lens actuating device is shut down with a normal shutdown; and
writing normal shutdown information into the microcontroller through the shutdown detection unit to, when the dual-motor lens actuating device is shut down with normal shutdown.

11. The dual-motor lens actuating method of claim 10, further comprising the steps of:
using the microcontroller to control the second driving motor to drive the pair of focus lens groups to rotate and move in second direction to a step with the farthest stroke, when the microcontroller has not read the normal shutdown information; and
using the microcontroller to control the first driving motor to drive the zoom lens group to rotate and move in second direction.

12. The dual-motor lens actuating method of claim 10, further comprising the steps of: using the microcontroller to receive the step signal corresponding to the zoom lens group, when the microcontroller has not read the normal shutdown information and the microcontroller controls the first driving motor to drive the zoom lens group to rotate and move in second direction; and
using the microcontroller to control the first driving motor to stop driving the zoom lens group to move, when the microcontroller has not received the step signal for a predetermined time.
